(19) United States
(12) Patent Application Publication
(10) Pub. No.: US 2021/0387924 A1
(43) Pub. Date: Dec. 16, 2021

(54) Use of Magnesium Sulfate Granulates In Solid Urea-Containing Fertilizer Compositions

(71) Applicant: K+S Aktiengesellschaft, Kassel (DE)

(72) Inventors: Guido BAUCKE, Schenklengsfeld OT Wippershain (DE); Armin Dietrich, Weissenborn (DE); David Scherr, Huenfeld (DE); Ludger Waldmann, Telgte (DE)

(73) Assignee: K+S Aktiengesellschaft, Kassel (DE)

(21) Appl. No.: 16/492,396

(22) PCT Filed: Mar. 7, 2018
(86) PCT No.: PCT/DE2018/000058

§ 371 Date: Sep. 9, 2019

(30) Foreign Application Priority Data
Mar. 8, 2017 (DE) 10 2017 104 876.6

(51) Int. Cl. C05C 9/00; C05G 5/12

(52) U.S. Cl. CPC C05C 9/00; C05G 5/12

(57) ABSTRACT

Magnesium sulfate granulates, having a dry loss of less than 2 wt. % determined by drying the granulate for 2 hours at 105° C. and 1 bar, are used for the production of solid urea-containing fertilizer compositions and to the thus produced fertilizer compositions.

The present invention relates to the use of magnesium sulfate granules for production of solid, urea-containing fertilizer compositions. The invention also relates to fertilizer compositions in solid, free-flowing form, comprising magnesium sulfate granules and urea in solid form, and to a process for producing these granules.

Even though magnesium, as the eighth most common element, is present to an extent of about 1.94% in the Earth's crust, soils are often deficient in magnesium. Therefore, magnesium salts are widely used as fertilizers or fertilizer additions. More particularly, magnesium sulfate is used as fertilizer or fertilizer additive, frequently in the form of the monohydrate or 5/4 hydrate. Magnesium sulfate is typically used here in the form of magnesium sulfate-containing granules optionally containing macronutrients such as potassium, phosphorus or nitrogen, and optionally trace elements such as manganese, zinc, copper, iron, molybdenum or boron.

It is frequently the case that fertilization using magnesium sulfate together with urea would be desirable. For instance, B. von Rheinbaben, Fertilizer Research 11 (1987) states that the joint use of magnesium sulfate monohydrate and urea leads to a reduction in nitrogen loss. However, there are limits to the joint use of magnesium and nitrogen. For instance, solid mixtures of magnesium sulfate granules and urea are not storage-stable. It is frequently the case that the two mixing partners and the surrounding air humidity react even after a short time, forming pasty masses that additionally readily undergo deliquescence and are therefore difficult to handle and can no longer be deployed as fertilizers in solid form. Even in the case of storage under dry conditions, clumping of the mixture, called agglomerates, is observed after a period of time. These problems occur especially in the case of granules having a high proportion of magnesium.

GB 1359884 suggests using aqueous concentrates that are obtained by mixing a magnesium sulfate containing water of hydration or water of crystallization, e.g. bitter salt (magnesium sulfate heptahydrate), with solid urea. But liquid fertilizer compositions are less suitable for some applications than solid fertilizer compositions.

WO 2013/098367 proposes solving this problem by using magnesium sulfate and urea in the form of a complex [MgSO₄.m CO(NH₂)₂.n H₂O] in which m is in the range from 0.9 to 1.1 and n is in the range from 2.9 to 3.1, where the compositions described therein may contain little or no free MgSO₄ and less than 10% by weight of unbound urea.

A similar approach to a solution is pursued by WO 2014/096372, wherein compositions containing mixtures of two magnesium sulfate-urea complexes are used. A disadvantage is that the complexes have to be prepared beforehand. Moreover, this permits only the use of magnesium sulfate and urea within a narrow ratio.

DE 4232567 describes the use of aqueous urea solutions for reducing the tendency of sulfate granules, for example of kieserite granules, to form dust.

It is therefore an object of the invention to provide magnesium sulfate granules that result in storage-stable fertilizer compositions when mixed with solid urea. The mixtures obtained should be storage-stable under ambient conditions, i.e. should not undergo deliquescence and as far as possible should not cake or form agglomerates. It is additionally desirable for the magnesium sulfate granules to be mechanically stable.

It has been found that, surprisingly, magnesium sulfate granules, especially those having a high magnesium content, when mixed with solid urea, do not have the problems outlined at the outset, but form free-flowing, storage-stable mixtures when magnesium sulfate granules having a drying loss of less than 2% by weight, preferably less than 1.5% by weight, particularly not more than 1% by weight and especially not more than 0.5% by weight, determined by drying the granules at 105° C. and 1 bar for 2 h, are used.

Accordingly, the present invention relates to the use of magnesium sulfate granules having a drying loss of less than 2% by weight, preferably less than 1.5% by weight, particularly not more than 1% by weight and especially not more than 0.5% by weight, determined by drying the granules at 105° C. and 1 bar for 2 h, for production of solid, urea-containing fertilizer compositions.

The fertilizer compositions obtained here are storage-stable and, even in the case of prolonged storage for 20 days or longer, for example, especially even after 30 days or longer, do not show any deliquescence or formation of agglomerates. The fertilizer compositions can be produced in a simple manner by mixing such magnesium sulfate granules with solid urea, especially with urea granules or prilled urea, without having to prepare a complex or dissolve the urea and introduce the solution into the granulation process beforehand. Therefore, such magnesium sulfate granules open up the production of fertilizer compositions having very different contents of solid urea.

Accordingly, the invention also relates to fertilizer compositions in solid, free-flowing form that contain magnesium sulfate granules having a low drying loss, as described here and hereinafter, and urea in solid form.

The invention therefore also relates to a process for producing such fertilizer compositions, in which magnesium sulfate granules having a low drying loss, as described here and hereinafter, and urea in solid form are mixed with one another.

The statements made here and hereinafter in relation to the magnesium sulfate granules and the urea are applicable in the same way to the use of the invention, the fertilizer compositions of the invention and the process of the invention for production thereof.

The magnesium sulfate granules used in accordance with the invention, by contrast with commercially available magnesium sulfate granules, have only a low drying loss. According to the invention, the magnesium sulfate granules have a drying loss of less than 2% by weight, preferably less than 1.5% by weight, particularly not more than 1.0% by weight and especially of not more than 0.5% by weight, for example, in the range from 0.01% to <1.5% by weight, particularly in the range from 0.05% to 1% by weight and especially in the range from 0.1% to 0.5% by weight, determined by drying the granules at 105° C. and 1 bar for 2 h.

Here and hereinafter, the terms dry loss and drying loss are used synonymously. This drying loss is typically determined in accordance with DIN EN 12880:2000 by drying a sample to constant weight at temperatures in the region of 105±5° C. at ambient pressure. In general, the drying is effected in a drying cabinet. The time needed to attain constant weight in the case of magnesium sulfate granules is typically below 2 h. The drying residue in % is ascertained here by weighing before and after the drying, based on the starting weight used. The drying loss in % is calculated from the drying residue in % by subtraction from 100.

Magnesium sulfate granules are understood to mean granules containing magnesium sulfate as the main constituent. The proportion of magnesium sulfate, based on the total mass of the constituents of the magnesium sulfate granules used in accordance with the invention, is generally at least 50% by weight, especially at least 60% by weight. As well as the magnesium sulfate, the magnesium sulfate granules may also contain a minor amount of other inorganic compounds, for example compounds from the group of MgO, MgCO₃, CaSO₄, Na₂SO₄, K₂SO₄, KCl and NaCl. The proportion of such compounds will generally not exceed 50% by weight, particularly 40% by weight and especially 10% by weight or 5% by weight, based on the total mass of the constituents of the magnesium sulfate granules used in accordance with the invention. The advantages of the invention are manifested especially when the magnesium sulfate granules consist of MgSO₄ to an extent of at least 90% by weight and especially at least 95% by weight, based on the constituents of the granules other than water.

In addition, the magnesium sulfate granules may also contain micronutrients. These include, as well as boron that has already been mentioned, the elements manganese, zinc, copper, iron and molybdenum, which are typically used in the granules in the form of their salts or complexes. Manganese, copper and zinc are preferably used in the form of their sulfates. Copper and iron are preferably also used in the form of chelates, for example with EDTA. Boron is preferably used in the form of calcium sodium borate, for example in the form of ulexite, sodium borate, potassium borate or boric acid. Molybdenum is preferably used in the form of sodium molybdate or ammonium molybdate or of a mixture thereof. Typically, the proportion of micronutrients other than boron, calculated in their elemental form, will not exceed 1% by weight, based on the total mass of the constituents of the magnesium sulfate granules used in accordance with the invention. The content of boron, calculated as B₂O₃, will generally not exceed 3% by weight and is typically, if present, in the range from 0.01% to 3% by weight, especially 0.01% to 2% by weight, based on the total mass of the constituents of the magnesium sulfate granules used in accordance with the invention.

In addition, the magnesium sulfate granules used in accordance with the invention may also contain organic binders, for example tylose, molasses, gelatin, starch, lignosulfonates or salts of polycarboxylic acids, such as sodium citrate or potassium citrate, or fatty acid salts such as calcium stearate. The proportion of the organic binders will typically not exceed 2% by weight and is preferably less than 1% by weight, based in each case on the total mass of the constituents of the magnesium sulfate granules used in accordance with the invention. In preferred embodiments, the magnesium sulfate granules used in accordance with the invention do not contain any organic binders. More particularly, no organic binders are required when the magnesium sulfate granules used in accordance with the invention are those that contain a synthetic magnesium sulfate as magnesium sulfate.

In addition, the granules of the invention may also contain water in the form of bound water of crystallization. The proportion of unbound water will typically not exceed the values specified for the drying loss. The proportion of bound water of crystallization may, for example, be up to 23% by weight and is frequently in the range from 7% to 23% by weight, especially in the range from 16% to 22% by weight, based on the total mass of the magnesium sulfate granules. The content of water of crystallization is generally determined via the ignition loss of the magnesium sulfate granules at 550° C.

As already mentioned at the outset, the advantages of the invention are manifested especially in the case of magnesium sulfate granules having a high proportion of magnesium salts. Such magnesium sulfate granules frequently have a content or proportion of magnesium of at least 17% by weight, particularly at least 18.5% by weight and especially at least 20% by weight, in each case calculated as MgO and based on the total mass of the magnesium sulfate granules used in accordance with the invention. The magnesium content in the magnesium sulfate granules will generally not exceed 30% by weight, calculated as MgO and based on the total mass of the magnesium sulfate granules used in accordance with the invention. Accordingly, the magnesium content is typically in the range from 17% to 30% by weight, particularly in the range from 18.5% to 30.0% by weight and especially in the range from 20% to 30% by weight, in each case calculated as MgO and based on the total mass of the magnesium sulfate granules used in accordance with the invention.

Frequently, the proportion of salts other than magnesium sulfate and magnesium oxide is less than 10% by weight, especially not more than 5% by weight, based on the total mass of the magnesium sulfate granules.

In the magnesium sulfate granules used in accordance with the invention, the magnesium is largely or entirely in water-soluble form. In addition, a portion of the magnesium present in the magnesium sulfate granules used in accordance with the invention may also be in the form of water-insoluble magnesium. The proportion of water-insoluble magnesium, calculated as MgO and based on the total mass of the magnesium sulfate granules used in accordance with the invention, will generally not be more than 7% by weight and is typically not more than 6% by weight, for example in the range from 0.1% to 7% by weight and especially in the range from 0.3% to 6% by weight. In the magnesium sulfate granules used in accordance with the invention, the proportion of water-insoluble magnesium is generally below 35% by weight, calculated as MgO and based on the total amount of water-insoluble magnesium and water-soluble magnesium, in each case calculated as MgO.

In the magnesium sulfate granules used in accordance with the invention, the magnesium sulfate is generally predominantly or entirely in hydrated form, especially in the form of magnesium sulfate monohydrate and/or magnesium sulfate 5/4 hydrate. Preferred hydrates of magnesium sulfate are especially natural magnesium sulfate monohydrate (kieserite) and synthetically produced magnesium sulfate hydrate (SMS) which consists predominantly of magnesium sulfate monohydrate. Preferred hydrates of magnesium sulfate are also mixtures in which the magnesium sulfate monohydrate (synthetic or natural) is present as the main constituent and which may optionally contain further hydrate such as magnesium sulfate 5/4 hydrate or magnesium sulfate dihydrate. Preferably, the proportion of magnesium sulfate monohydrate and magnesium sulfate 5/4 hydrate in the magnesium sulfate granules used in accordance with the invention is at least 90% by weight, based on the total mass of magnesium sulfate plus water of hydration of the magnesium sulfate. Particular preference is given to magnesium sulfate granules in which the magnesium is present in the magnesium sulfate granules in the form of magnesium sulfate monohydrate to an extent of at least 90% by weight, based on the total amount of magnesium sulfate plus any water of hydration of the magnesium sulfate.

In a particularly preferred embodiment, the magnesium sulfate granules used in accordance with the invention are those consisting of synthetic magnesium sulfate hydrate to an extent of at least 90% by weight, particularly to an extent of at least 95% by weight and especially to an extent of at least 98% by weight. By comparison with granules based on other magnesium sulfate hydrates, such granules surprisingly feature better mechanical properties such as higher fracture resistances and lower abrasion even in the dried state, i.e. at drying losses below 2% by weight, especially below 1% by weight. Owing to their improved mechanical properties, they have improved transportability.

Synthetic magnesium sulfate hydrate, also SMS hereinafter, is understood to mean a magnesium sulfate hydrate obtainable by digesting magnesium oxide with sulfuric acid, especially with a 50% to 90% by weight aqueous sulfuric acid. By comparison with magnesium sulfate hydrate from natural sources such as kieserite, SMS generally contains smaller amounts of halides and a higher proportion of water-insoluble magnesium in the form of water-insoluble magnesium oxide. More particularly, the proportion of water-insoluble magnesium, based on the total mass of the SMS and calculated as MgO, is in the range from 1.5% to 7.0% by weight, especially in the range from 2.0% to 6.0% by weight. The proportion of salts other than magnesium sulfate and magnesium oxide is generally less than 3% by weight, especially less than 2.5% by weight, based on the total mass of the SMS. The total content of magnesium (water-soluble MgO and water-insoluble MgO) in the SMS is generally at least 26% by weight, particularly at least 27% by weight, calculated as MgO, and is frequently in the range from 26% to 30% by weight, especially 27% to 30% by weight.

In the SMS, the magnesium sulfate is mainly in the form of magnesium monohydrate or of a mixture of magnesium sulfate monohydrate with magnesium sulfate 5/4 hydrate, where small amounts of magnesium sulfate dihydrate may also be present in the SMS. Preferably, the proportion of magnesium sulfate monohydrate and magnesium sulfate 5/4 hydrate in the SMS is at least 90% by weight, based on the total mass of the SMS. Particular preference is given to magnesium sulfate granules in which the magnesium sulfate in the SMS is in the form of magnesium sulfate monohydrate to an extent of at least 90% by weight, based on the total amount of magnesium sulfate plus water of hydration. More particularly, the content of water of crystallization in the magnesium sulfate granules is 18.0% to 22% by weight, based on the total mass of the SMS and determined via the ignition loss at 550° C.

Accordingly, magnesium sulfate granules consisting of synthetic magnesium sulfate hydrate to an extent of at least 90% by weight, particularly to an extent of at least 95% by weight, especially to an extent of at least 98% by weight, frequently have at least one of or all the following features:

The proportion of water-soluble magnesium, based on the total mass of such magnesium sulfate granules and calculated as MgO, is in the range from 20% to 25% by weight, especially 22% to 25% by weight.
The proportion of water-insoluble magnesium, based on the total mass of such magnesium sulfate granules and calculated as MgO, is in the range from 1.5% to 7.0% by weight, especially in the range from 2.0% to 6.0% by weight.
The total content of magnesium (water-soluble MgO and water-insoluble MgO), based on the total mass of such magnesium sulfate granules and calculated as MgO, is generally at least 26% by weight, particularly at least 27% by weight, and is frequently in the range from 26% to 30% by weight, especially 27% to 30% by weight.
The proportion of water of hydration, determined by ignition loss at 550° C., is 18.0% to 22% by weight, based on the total mass of such magnesium sulfate granules.
The proportion of monohydrate and/or −5/4 hydrate, based on the total mass of the magnesium sulfate+water of hydration present in the magnesium sulfate granules, is at least 90% by weight. More particularly, the proportion of monohydrate, based on the total mass of the magnesium sulfate+water of hydration present in the magnesium sulfate granules, is at least 90% by weight.
The proportion of salts other than magnesium sulfate and magnesium oxide is less than 3.0% by weight, especially not more than 2.5% by weight, based on the total mass of such magnesium sulfate granules.

Such granules based on synthetic magnesium sulfate hydrate, even in the case of drying losses of below 2% by weight, particularly not more than 1% by weight and especially not more than 0.5% by weight, for example 0.05% to 1% by weight and especially 0.1% to 0.5% by weight, have a fracture resistance or cracking resistance of at least 30 N, particularly at least 35 N, especially at least 40 N, e.g. 30 to 70 N, particularly 35 to 60 N and especially 40 to 45 N. The abrasion of such granules even in the case of the abovementioned drying losses is generally below 2% by weight, particularly below 1.5% by weight and especially below 1% by weight.

The cracking resistance values reported here and hereinafter are averages that have been ascertained by measuring the cracking resistance of 56 granules in the particle size range from 2.5 to 3.15 mm. The terms “cracking resistance” and “fracture resistance” are used synonymously.

The abrasion values reported here and hereinafter were determined by the rolling drum process according to Busch (see also rolling drum method No. 5 in H. Rieschel, K. Zech, Vergleich verschiedener Prüfmethoden zur Qualitätsprüfung von Kaligranulat [Comparison of Various Test Methods for Testing the Quality of Potash Granules]. No. 10.3. Reprint from “Aufbereitungs-Technik”, Hattingen, edition September 1981).

Preferably, the magnesium sulfate granules used in accordance with the invention have a small proportion of particles having a particle size or grain size below 1 mm. In particular, the proportion of granule particles, granules hereinafter, having a grain size below 1 mm is less than 10% by weight, especially less than 5% by weight. For use in fertilizers, it is also advantageous when less than 10% by weight of the granules in the magnesium sulfate granules has a grain size below 2 mm. Frequently at least 60% by weight, particularly at least 80% by weight and especially at least 90% by weight of the granules have a grain size of less than 5 mm. Preferably, the grain size of the granules is in the range from 2 to 5 mm to an extent of at least 60% by weight, particularly to an extent of at least 80% by weight and especially to an extent of at least 90% by weight. The distribution of the grain sizes of the granules can be determined by sieve analysis in a manner known per se and is based on the diameter of the granules.

The magnesium sulfate granules used in accordance with the invention are generally not commercially available. However, they can be produced from commercially available magnesium sulfate granules in a simple manner by drying. The drying is preferably effected at temperatures in the range from 90 to 130° C., but can also be effected at lower temperatures or higher temperatures. The drying temperature of 200° C. is preferably not exceeded in order to avoid complete dehydration. The drying is typically effected at ambient pressure or in the range from 900 to 1200 mbar, although higher or lower pressures may be employed. The drying time is guided in particular by the drying temperature and is generally conducted until the desired drying loss has been attained. The duration needed for the purpose can be ascertained by routine studies. The drying time is generally 0.1 to 4 h. The drying can be effected in the apparatus customary for the drying of granules, such as belt driers, rotary furnaces, drying drums, fluidized bed driers or pan driers.

The magnesium sulfate granules to be dried can be produced in analogy to processes known per se for production of granules from finely divided inorganic salts, as known, for example, from the prior art cited at the outset and described, for example, in Wolfgang Pietsch, Agglomeration Processes, Wiley—VCH, 1st edition, 2002, in G. Heinze, Handbuch der Agglomerationstechnik [Handbook of Agglomeration Technology], Wiley—VCH, 2000, and in Perry's Chemical Engineers' Handbook, 7th edition, McGraw-Hill, 1997, p. 20-56 to 20-89.

More particularly, the magnesium sulfate granules to be dried are produced by buildup agglomeration of finely divided synthetic magnesium sulfate hydrate with addition of small amounts of water in order to achieve wetting and agglomeration of the finely divided synthetic magnesium sulfate hydrate owing to capillary forces. In general, water is used in an amount in the range from 3% to 15% by weight, especially in an amount from 5% to 10% by weight, based on the starting material to be granulated. The use of other binders is not required and therefore generally amounts to not more than 0.1% by weight, based on the starting material to be granulated.

Buildup agglomeration can be effected in a manner known per se as a rolling agglomeration, mixing agglomeration or fluidized bed agglomeration, especially as a rolling agglomeration. In rolling agglomeration, the raw material to be granulated will be introduced into a vessel with an inclined axis of rotation and circular cross section, preferably into a granulating drum or onto a granulating pan. By rotating the vessel, the particles of the fine salt are set in motion. The treatment with the water is effected, for example, by spraying onto the magnesium sulfate that has been set in motion. This affords comparatively uniform, round granules that can be sent directly to a classification and/or drying.

In a specific embodiment, the granulation apparatus used for the rolling agglomeration is an apparatus having a cylindrical rotating vessel to accommodate the constituents to be granulated, the axis of rotation of which is inclined relative to the vertical, wherein the vessel has at least one rotating mixing tool arranged eccentrically with respect to the center of rotation of the vessel, especially a rotating mixing tool with multiple paddles in the form of blades that are arranged on a rotating shaft and at least one scraper arranged eccentrically with respect to the center of rotation of the vessel. Such granulating apparatuses are known and commercially available, for example as Eirich intensive mixers from Maschinenfabrik Gustav Eirich GmbH & Co. KG, Hardheim, Germany.

According to the invention, the magnesium sulfate granules described here are used for production of solid, urea-containing fertilizer compositions. In these fertilizer compositions, the urea is naturally in solid, particulate form. They are especially suitable for production of solid fertilizer compositions in which the urea is in prilled form or in the form of granules. The prills or granules generally have a urea content of at least 95% by weight, especially at least 98% by weight. The nitrogen content is frequently about 46% by weight. The grain size of the solid urea is typically in the range from 1 to 4 mm, i.e. at least 90% by weight of the prills or of the granule grains have a grain size within this range.

The magnesium sulfate granules of the invention are especially suitable for production of solid fertilizer compositions having a high urea content, especially those in which the mass ratio of magnesium sulfate granules to urea is in the range from 2:1 to 1:10 and especially in the range from 1.5:1 to 1:3.

The solid urea-containing fertilizer compositions consist generally to an extent of at least 60% by weight, based on the total mass of the fertilizer composition, of a mixture of magnesium sulfate granules and urea. As well as the magnesium sulfate granules and the urea, the fertilizer compositions may also contain further fertilizer constituents. These firstly include potassium-containing fertilizers such as potassium sulfate (SOP) and potassium chloride (MOP), and also mixed granules, and additionally phosphorus-containing fertilizers such as superphosphate and triple superphosphate (TSP). These further fertilizers will typically likewise be in solid form, especially in granule form, in the fertilizer composition.

As well as the aforementioned constituents, the fertilizer compositions may contain urease inhibitors and/or nitrification inhibitors. Suitable urease inhibitors are known to those skilled in the art, for example from Kiss et al. (Kiss, S., Simih\check{a}ian, M. 2002, Improving Efficiency of Urea Fertilizers by Inhibition of Soil Urease Activity, ISBN 1-4020-0493-1, Kluwer Academic Publishers, Dordrecht, the Netherlands). Suitable urease inhibitors are in particular N-alkylphosphoramides and N-alkylthiophosphoramides and mixtures thereof, as known, for example, from WO 2009/079994 and the literature cited therein. Preference is given to N-n-butylthiophosphoramide (NBPT), N-n-propylthiophosphoramide (NPPT) and mixtures thereof. Suitable nitrification inhibitors, as well as dicyandiamide, are in particular pyrazoles and the acid addition salts thereof, especially the phosphoric acid addition salts and thiosulfate salts thereof, and also 1-carboxyalkylpyrazoles and mixtures thereof. It is possible here for the pyrazoles and 1-carboxyalkylpyrazoles to be substituted on the carbon atoms by one or more, e.g. one or two, substituents from the group of C₁-C₄-alkyl, especially methyl. Such compounds and their use as nitrification inhibitors are known, for example, from U.S. Pat. Nos. 3,635,690, 4,969,946, EP 0808298 and EP 1120388. Preferred nitrification inhibitors are 3-methylpyrazole compounds such as 3-methylpyrazole and the acid addition salts thereof, and also 3,4-dimethylpyrazole (DMP) compounds such as 2-(3,4-dimethylpyrazol-1-yl)succinic acid, N-hydroxymethyl-3,4-dimethylpyrazole and the acid addition salts thereof, and in particular 3,4-dimethylpyrazole and the acid addition salts of 3,4-dimethylpyrazole, especially its phosphoric acid addition salts (DMPP) and thiosulfate salts.

Such fertilizer compositions contain at least one further constituent from the group of nitrification inhibitors and urease inhibitors generally in an amount of 0.001% to 5% by weight, especially in an amount of 0.002% to 3% by weight, based on the total weight of the fertilizer composition. If such fertilizer compositions contain at least one urease inhibitor, the concentration of urease inhibitor is generally 0.001% to 3% by weight, especially 0.002% to 2% by weight, based on the urea in the fertilizer composition. If such fertilizer compositions contain at least one nitrification inhibitor, the concentration of nitrification inhibitor is generally 0.01% to 3% by weight, especially 0.02% to 2% by weight, based on the total weight of the fertilizer composition, calculated as salt in the case of acid addition salts of pyrazole compounds. If such fertilizer compositions contain at least one urease inhibitor and at least one nitrification inhibitor, the total concentration of nitrification inhibitor+urease inhibitor is generally 0.011% to 5% by weight, especially 0.022% to 3% by weight, based on the total weight of the fertilizer composition. Typically, in that case, the weight ratio of the at least one nitrification inhibitor to the at least one urease inhibitor is generally 1:10 to 10:1 and preferably 1:5 to 5:1.

The fertilizer compositions may optionally contain micronutrients such as manganese, zinc, copper, iron, molybdenum and/or boron. Manganese, copper and zinc are preferably used in the form of their sulfates. Copper and iron are preferably also used in the form of chelates, for example with EDTA. Boron is preferably used in the form of calcium sodium borate, sodium borate, potassium borate or boric acid. Molybdenum is preferably used in the form of sodium molybdate or ammonium molybdate or of a mixture thereof. These constituents may be present in the magnesium sulfate granules or in the further fertilizer constituents or be added separately.

The solid, free-flowing fertilizer composition is produced by mixing magnesium sulfate granules as defined here and urea in solid form, especially in the form of granules or prills, and optionally the further fertilizer constituents. The constituents will be used here so as to result in the aforementioned ratios. The mixing can be effected in the manner customary for the blending of particulate solids, especially of grainy solids such as granules and prills. Suitable apparatuses for the blending are freefall mixers with and without internals, such as drum mixers and ring mixers, paddle mixers such as trough mixers, plowshare mixers and twin-shaft mixers, and screw mixers.

The fertilizer compositions thus obtained are storage-stable and do not have a tendency to cake or deliquesce even after prolonged storage.

The examples that follow serve to illustrate the invention.

Drying loss TV was determined in accordance with DIN EN 12880:2000 by drying a sample of about 30 g in a drying cabinet at temperatures in the region of 105±5° C. at ambient pressure for 2 h and determining the weight of the sample before and after the drying.

Cracking resistance or fracture resistance was ascertained with the aid of the TBH 425D tablet hardness tester from ERWEKA on the basis of measurements on 56 individual granules of different particle size (2.5-3.15 mm fraction), and the average was calculated. The force required to break the granule between the ram and plate of the fracture resistance tester was determined. Granules having a cracking resistance >400 N and those having a cracking resistance <4 N were not included in the formation of the average.

The abrasion values were determined by the rolling drum process according to Busch. For this purpose, 50 g of the granules having a grain size fraction of 2.5-3.15 mm together with 70 steel balls (diameter 10 mm, 283 g) were introduced into a rolling drum of a commercial abrasion tester, e.g. ERWEKA, model: TAR 20, and rolled at 40 rpm for 10 min. Subsequently, the contents of the drum were sieved onto a sieve having a mesh size of 5 mm, below which was disposed a sieve having a mesh size of 0.5 mm, on a sieving machine (model: Retsch AS 200 control) for 1 min. The fines fraction sieved off corresponds to the abrasion.

In the performance test, magnesium sulfate granules were used that were composed of synthetic magnesium sulfate monohydrate produced in the following manner:

Calcined magnesite (MgO content about 80-85%) was reacted with about 70% by weight aqueous sulfuric acid in a molar Mg:H₂SO₄ ratio of about 0.9. Immediately after the reaction, the solid product obtained at a temperature of about 115-120° C. was processed in a pelletizing pan with application by jet nozzle of about 5% to 10% by weight of water to give granules that were then dried on a maturing belt with a dwell time of 1 h. Subsequent classifying gave magnesium sulfate granules having a total magnesium content of 27% by weight, calculated as MgO, and a proportion of water-soluble magnesium of 22.5% by weight, calculated as MgO. About 93% by weight of the granule particles had a grain size in the range from 2 to 5 mm. The proportion of particles having a grain size above 5 mm was less than 1% by weight. The proportion of particles having a grain size below 1 mm was likewise less than 1% by weight. The drying loss of the granules used was about 7% to 9% by weight.

### Performance Testing:

The urea used was a commercial urea prill having a nitrogen content of 47% by weight and a grain size of about 0.8 to 2.5 mm. The weight-average diameter (d₅₀) was 1.64 mm.

For the experiments, the magnesium sulfate granules were spread out homogeneously on a metal sheet and placed into the heated cabinet at 130° C. for 15, 20, 25 or 30 minutes. One day later, the samples were divided into 4 fractions in a sample splitter. One fraction was used to measure abrasion and one to measure cracking resistance (fractions 1 and 2). Fraction 3 was used to determine drying loss (TV). Fraction 4 was used to conduct the storage test. In addition, the undried magnesium sulfate granules were analyzed as blank sample. Table 1 lists the physical properties of the dried granules thus produced:

TABLE 1
Physical properties of the
magnesium sulfate granules

| Time in | | | |
|---|---|---|---|
| the drying | Cracking | | |
| cabinet | resistance | Abrasion | TV |
| 0 min* | 82 N | 0.1% | 7.3% |
| 15 min* | 65 N | 0.6% | 4.5% |
| 20 min | 60 N | 1.4% | 1.7% |
| 25 min | 62 N | 1.8% | 0.8% |
| 30 min | 62 N | 2.2% | 0.1% |

* comparative granules

For the determination of storage stability, the magnesium sulfate granules thus dried were mixed with the urea prills in a weight ratio of 1:1. Subsequently, the mixture was stored at 28° C. and a relative air humidity of 85% RH for 5 minutes, and the sample thus weathered was transferred to a glass vessel that can be closed airtight. The closed sample was then stored at 35° C. for a total of 44 days. At regular time intervals, the mixtures were assessed visually and graded by the following grades:
Grade 1: dry; the granules are in their initial state
Grade 2: first grains become tacky; slightly agglomerating; some individual grains look “moist”, urea/magnesium sulfate aggregates usually form
Grade 3: partly moistened through; agglomerates of “tacky” urea/magnesium sulfate aggregates form, limited flowability
Grade 4: completely moistened through; the entire mixture is moist or wet to an extent of at least 80% by weight, caked and barely still free-flowing; liquid droplets are apparent in some cases

The results are compiled in table 2:

TABLE 2
Assessment of storage stability of the fertilizer compositions

| | TV | Storage time | | | | | | | | | | | | |
|---|---|---|---|---|---|---|---|---|---|---|---|---|---|---|
| Sample* | [%] | 1 d | 2 d | 3 d | 4 d | 7 d | 9 d | 10 d | 15 d | 17 d | 23 d | 30 d | 37 d | 44 d |
| 0 min | 7.3% | 4 | 4 | 4 | 4 | 4 | 4 | 4 | 4 | 4 | 4 | 4 | 4 | 4 |
| 15 min | 4.5% | 1 | 1 | 1 | 2 | 2 | 2 | 2 | 2 | 2 | 2 | 3 | 3 | 3 |
| 20 min | 1.7% | 1 | 1 | 1 | 1 | 1 | 1 | 1 | 1 | 1 | 2 | 2 | 2 | 2 |
| 25 min | 0.8% | 1 | 1 | 1 | 1 | 1 | 1 | 1 | 1 | 1 | 1 | 1 | 1 | 1 |
| 30 min | 0.1% | 1 | 1 | 1 | 1 | 1 | 1 | 1 | 1 | 1 | 1 | 1 | 1 | 1 |

*Time in the drying cabinet

In a further experiment, the magnesium sulfate, before being applied to a pelletizing pan, was mixed with a defined amount of micronutrients and then processed to give granules with application by jet nozzle of 5% to 11% % by weight of water. As micronutrients, 3.3% by weight of borax pentahydrate and 2.9% by weight of zinc sulfate monohydrate were mixed in, which corresponds to a boron content, calculated as B₂O₃, of 1.6% by weight and a zinc content, calculated as elemental zinc, of 1.0% by weight. It was found here that the mixture of magnesium sulfate hydrate, borax pentahydrate and zinc sulfate monohydrate could be granulated efficiently. The drying loss of the granules was 10.6% by weight; the proportion of water-soluble magnesium was determined as 22.6% by weight, calculated as MgO. Cracking resistance based on measurements on 56 individual granules of different particle size (2.5-3.15 mm fraction) was found to be 59 N, and abrasion to be 4.4% by weight.

1. A method for producing a solid, urea-containing fertilizer composition, the method comprising:
mixing magnesium sulfate granules, having a drying loss of less than 2% by weight, determined by drying the granules at 105° C. and 1 bar for 2 h, and urea.

2. The method as claimed in claim 1, wherein the magnesium sulfate granules have a magnesium content of at least 20% by weight, calculated as MgO and based on the total weight of the magnesium sulfate granules.

3. The method as claimed in claim 1, wherein magnesium sulfate in the magnesium sulfate granules is in the form of magnesium sulfate monohydrate to an extent of at least 90% by weight.

4. The method as claimed in claim 1, wherein at least 90% by weight of the magnesium sulfate granules have a grain size in the range from 2 to 5 mm.

5. The method as claimed in claim 1, wherein the magnesium sulfate granules comprise MgSO₄ to an extent of at least 90% by weight, based on the constituents of the magnesium sulfate granules other than water.

6. The method as claimed in claim 1, wherein the magnesium sulfate granules comprise synthetic magnesium sulfate hydrate to an extent of at least 90% by weight, based on the total mass of the magnesium sulfate granules.

7. The method as claimed in claim 1, wherein the weight ratio of magnesium sulfate granules to urea in the solid, urea-containing fertilizer composition is in the range from 2:1 to 1:10.

8. The method as claimed in claim 1, wherein the urea in the solid, urea-containing fertilizer composition is in the form of a prilled urea or granulated urea.

9. The method as claimed in claim 1, wherein the solid, urea-containing fertilizer composition comprises a mixture of magnesium sulfate granules and urea to an extent of at least 60% by weight, based on the total mass of the solid, urea-containing fertilizer composition.

10. A fertilizer composition in solid, free-flowing form, comprising:
magnesium sulfate granules, having a drying loss of less than 2% by weight, determined by drying the granules at 105° C. and 1 bar for 2 h, and
urea in solid form.

11. The fertilizer composition as claimed in claim 10, comprising:
at least 60% by weight, based on the total mass of the fertilizer composition, of a mixture of magnesium sulfate granules and urea.

12. The fertilizer composition as claimed in claim 10, in which the weight ratio of magnesium sulfate granules to urea is in the range from 2:1 to 1:10.

13. The fertilizer composition as claimed in claim 10, in which the urea is in the form of prilled urea or granulated urea.

14. A process for producing the fertilizer composition in solid, free-flowing form as claimed in claim 10, comprising:
mixing magnesium sulfate granules, having a drying loss of less than 2% by weight, determined by drying the granules at 105° C. and 1 bar for 2 h, and
urea in solid forms.

15. The process according to claim 14, wherein the urea in solid form is in the form of urea prills or urea granules.

16. The method as claimed in claim 1, wherein the magnesium sulfate granules consist of MgSO₄ to an extent of at least 90% by weight, based on the constituents of the magnesium sulfate granules other than water.

17. The method as claimed in claim 1, wherein the magnesium sulfate granules consist of synthetic magnesium sulfate hydrate to an extent of at least 90% by weight, based on the total mass of the magnesium sulfate granules.

18. The method as claimed in claim 1, wherein the solid, urea-containing fertilizer composition consist of a mixture of magnesium sulfate granules and urea to an extent of at least 60% by weight, based on the total mass of the solid, urea-containing fertilizer composition.

19. The fertilizer composition as claimed in claim 10,
consisting to an extent of at least 60% by weight, based on the total mass of the fertilizer composition, of a mixture of magnesium sulfate granules and urea.
